(19) United States
(12) Patent Application Publication
(10) Pub. No.: US 2024/0393588 A1
(43) Pub. Date: Nov. 28, 2024

(54) IMAGE DISPLAY DEVICE

(71) Applicant: Panasonic Automotive Systems Co., Ltd., Kanagawa (JP)

(72) Inventors: Kosuke IMAWAKA, Kyoto (JP); Hiroyuki FURUYA, Osaka (JP)

(73) Assignee: Panasonic Automotive Systems Co., Ltd., Kanagawa (JP)

(21) Appl. No.: 18/797,112

(22) Filed: Aug. 7, 2024

Related U.S. Application Data
(63) Continuation of application No. PCT/JP2022/039364, filed on Oct. 21, 2022.

(30) Foreign Application Priority Data
Feb. 10, 2022 (JP) 2022-019348

(51) Int. Cl. G02B 27/01

(52) U.S. Cl. CPC G02B 27/0103; G02B 27/0149; G02B 2027/0154

(57) ABSTRACT

An image display device includes: a hologram light guide plate; and a display light generator configured to cause a plurality of types of display light whose states are different from each other in a predetermined optical characteristic to be incident on the hologram light guide plate. The hologram light guide plate includes a first emission region having a hologram for causing a first type of the display light to form an image, a second emission region having a hologram for causing a second type of the display light to form an image, and a distribution region configured to guide the first type of the display light and the second type of the display light, out of the plurality of types of incident display light, to the first emission region and the second emission region, respectively.

### CROSS REFERENCE TO RELATED APPLICATION

This application is a continuation of International Application No. PCT/JP2022/039364 filed on Oct. 21, 2022, entitled “IMAGE DISPLAY DEVICE”, which claims priority under 35 U.S.C. Section 119 of Japanese Patent Application No. 2022-019348 filed on Feb. 10, 2022, entitled “IMAGE DISPLAY DEVICE”. The disclosures of the above applications are incorporated herein by reference.

### BACKGROUND OF THE INVENTION

### Field of the Invention

The present invention relates to an image display device that displays an image and that is, for example, suitable to be mounted on a moving body such as a passenger car.

### Description of Related Art

In recent years, an image display device referred to as a head-up display has been developed and mounted on a moving body such as a passenger car. In a head-up display mounted on a passenger car, light modulated by image information is projected toward a windshield, and reflected light thereof is applied to the eyes of a driver. Accordingly, the driver is allowed to see a virtual image as an image in front of the windshield. For example, drive assist information, such as a vehicle speed, various warning markers, and an arrow indicating the travelling direction of the passenger car, is displayed as a virtual image.

Japanese Laid-Open Patent Publication No. 2021-56535 describes an optical system that includes a light source, three beam splitters, three shutters, and three LOEs (e.g., planar waveguides). The beam from the light source is split into three beams by the three beam splitters. The three beams propagate along the three LOEs, respectively, and are emitted from the optical system. At this time, two of the three beams are selectively blocked through the shutters, and the remaining one beam is emitted from the optical system.

In the configuration of Japanese Laid-Open Patent Publication No. 2021-56535, since two of the three beams are blocked by the shutters, the utilization efficiency of the light emitted from the light source is reduced.

### SUMMARY OF THE INVENTION

An image display device according to a main aspect of the present invention includes: a hologram light guide plate; and a display light generator configured to cause a plurality of types of display light whose states are different from each other in a predetermined optical characteristic to be incident on an incident region of the hologram light guide plate. The hologram light guide plate includes a first emission region having a hologram for causing a first type of the display light to form an image, a second emission region having a hologram for causing a second type of the display light to form an image, and a distribution region having a hologram dependent on the optical characteristic and configured to guide the first type of the display light and the second type of the display light, out of the plurality of types of display light incident from the incident region, to the first emission region and the second emission region, respectively.

In the image display device according to this aspect, when the first type of the display light is incident from the incident region, the display light is guided to the first emission region by the distribution region, and when the second type of the display light is incident from the incident region, the display light is guided to the second emission region by the distribution region. Therefore, the utilization efficiency of each type of display light can be increased. In addition, such distribution of display light can be realized simply by placing the distribution region, which has the hologram dependent on the optical characteristic, in the hologram light guide plate. Thus, complication and size increase of the hologram light guide plate can be suppressed, resulting in simplification and cost reduction of the image display device.

The effects and the significance of the present invention will be further clarified by the description of the embodiments below. However, the embodiments below are merely examples for implementing the present invention. The present invention is not limited to the description of the embodiments below in any way.

### BRIEF DESCRIPTION OF THE DRAWINGS

FIG. 1A and FIG. 1B are diagrams schematically showing a use form of an image display device according to Embodiment 1;

FIG. 1C is a diagram schematically showing a configuration of the image display device according to Embodiment 1;

FIG. 2 is a diagram schematically showing a configuration of a display light generator of the image display device and configurations of circuits used for the display light generator according to Embodiment 1.

FIG. 3 is a perspective view schematically showing a configuration of a hologram light guide plate according to Embodiment 1.

FIG. 4 is a plan view schematically showing the configuration of the hologram light guide plate according to Embodiment 1.

FIG. 5 is a timing chart schematically showing driving of laser light sources, a spatial light modulator, and an actuator of a half-wave plate according to Embodiment 1.

FIG. 6 is a diagram schematically showing a near-distance image and a far-distance image which are virtual images formed in a space in front of a projection region according to Embodiment 1.

FIG. 7A and FIG. 7B are each a diagram schematically showing a near-distance image which is a virtual image formed in a space in front of a projection region according to Modification 1.

FIG. 8A and FIG. 8B are each a diagram schematically showing a near-distance image which is a virtual image formed in a space in front of a projection region according to Modification 2.

FIG. 9 is a perspective view schematically showing a configuration of a hologram light guide plate according to Embodiment 2.

FIG. 10 is a plan view schematically showing the configuration of the hologram light guide plate according to Embodiment 2.

FIG. 11 is a timing chart schematically showing driving of laser light sources and a spatial light modulator according to Embodiment 2.

FIG. 12 is a diagram schematically showing near-distance images and a far-distance image which are virtual images formed in a space in front of a projection region according to Embodiment 2.

It should be noted that the drawings are solely for description and do not limit the scope of the present invention by any degree.

### DETAILED DESCRIPTION

Hereinafter, an embodiment of the present invention will be described with reference to the drawings. For convenience, in each drawing, X, Y, and Z axes that are orthogonal to each other are additionally shown as appropriate.

### Embodiment 1

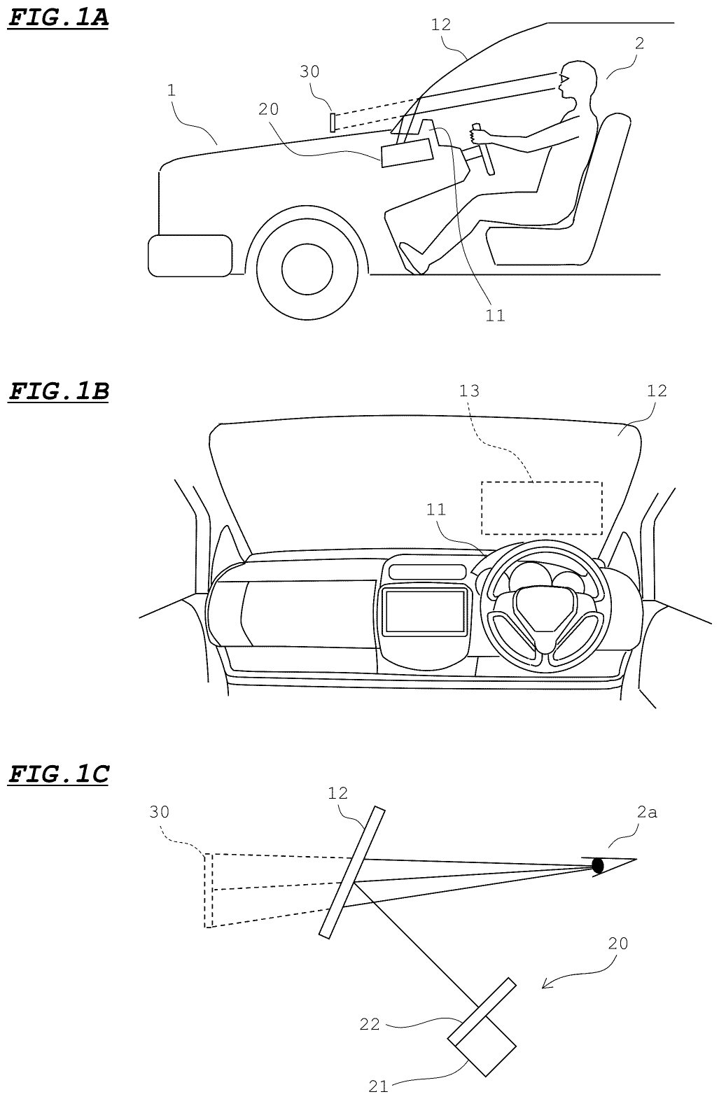

FIG. 1A and FIG. 1B are diagrams schematically showing a use form of an image display device 20. FIG. 1A is a schematic diagram in which the inside of a passenger car 1 is seen through from a lateral side of the passenger car 1, and FIG. 1B is a diagram when the front in a travelling direction is viewed from the inside of the passenger car 1.

In the present embodiment, the present invention is applied to a vehicle-mounted head-up display. As shown in FIG. 1A, the image display device 20 is installed within a dashboard 11 of the passenger car 1.

As shown in FIG. 1A and FIG. 1B, the image display device 20 projects display light modulated by an image signal onto a projection region 13 that is on a lower side of a windshield 12 and near a driver's seat. The projected display light is reflected by the projection region 13 and applied to a horizontally long region (eye box region) around the positions of the eyes of a driver 2. Accordingly, a predetermined image 30 is displayed as a virtual image in the front field of view of the driver 2. The driver 2 is allowed to see the image 30, which is a virtual image, such that the image 30 is superimposed on a view in front of the windshield 12. That is, the image display device 20 forms the image 30, which is a virtual image, in a space in front of the projection region 13 of the windshield 12.

FIG. 1C is a diagram schematically showing a configuration of the image display device 20.

The image display device 20 includes a display light generator 21 and a hologram light guide plate 22. The display light generator 21 generates display light modulated by the image signal, and emits the generated display light. The hologram light guide plate 22 causes the display light emitted from the display light generator 21 to propagate therethrough, and guides the display light to the projection region 13 of the windshield 12. The display light reflected by the windshield 12 is applied to eyes 2a of the driver 2. An optical system of the display light generator 21 and the hologram light guide plate 22 are designed such that the image 30, which is a virtual image, is displayed in front of the windshield 12 in a predetermined size.

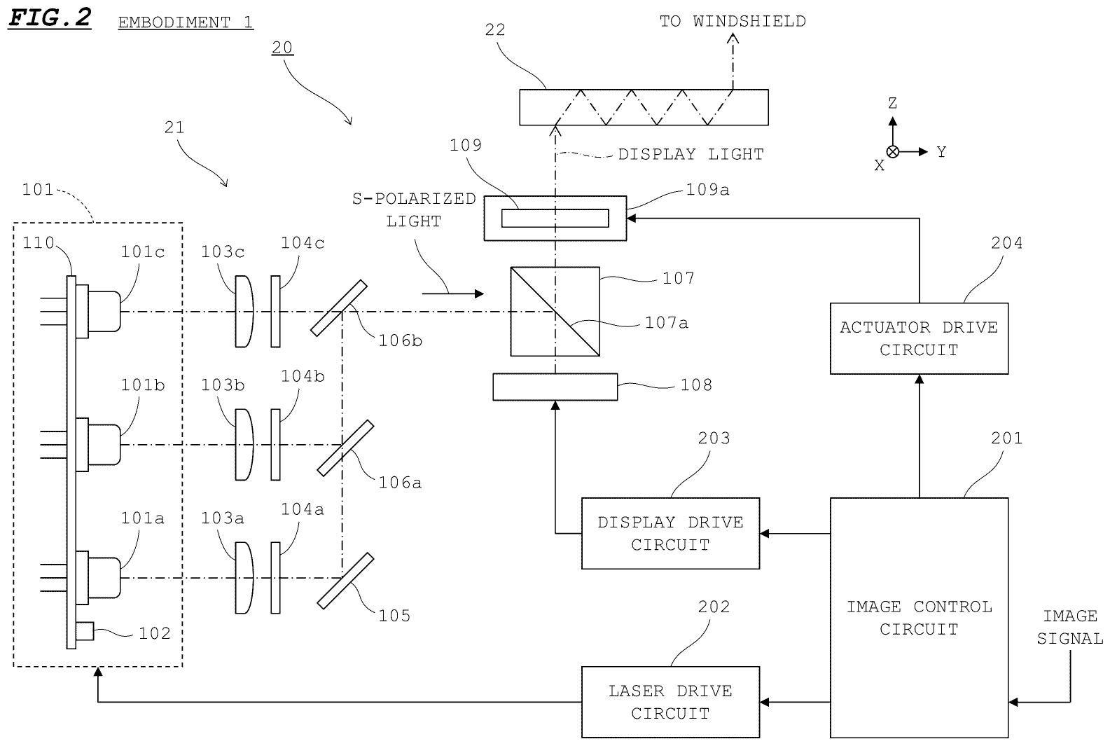

FIG. 2 is a diagram schematically showing a configuration of the display light generator 21 of the image display device 20 and configurations of circuits used for the display light generator 21.

The display light generator 21 includes a light source 101, a temperature sensor 102, collimator lenses 103a to 103c, apertures 104a to 104c, a mirror 105, dichroic mirrors 106a and 106b, a polarizing beam splitter 107, a spatial light modulator 108, and a half-wave plate 109.

The light source 101 includes three laser light sources 101a, 101b, and 101c.

The laser light source 101a emits laser light having a red wavelength included in the range of 635 nm or more and 645 nm or less in response to a drive signal. The laser light source 101b emits laser light having a green wavelength included in the range of 510 nm or more and 530 nm or less in response to a drive signal. The laser light source 101c emits laser light having a blue wavelength included in the range of 440 nm or more and 460 nm or less in response to a drive signal.

In the present embodiment, in order to display a color image as the image 30, the light source 101 includes these three laser light sources 101a, 101b, and 101c. The laser light sources 101a, 101b, and 101c are each composed of, for example, a semiconductor laser. In the case of displaying a single-color image as the image 30, the light source 101 may include only one laser light source corresponding to the color of the image. In addition, the light source 101 may include two laser light sources having different emission wavelengths.

The laser light sources 101a, 101b, and 101c are installed on one circuit board 110, and the temperature sensor 102 for detecting temperature (ambient temperature) near the installation location of the laser light sources 101a, 101b, and 101c is installed on the circuit board 110. The temperature sensor 102 is installed in the vicinity of the laser light source 101a which emits the laser light having a red wavelength. That is, the temperature sensor 102 is placed at a position closer to the laser light source 101a than to the other laser light sources 101b and 101c. A temperature sensor may be placed for each of the laser light sources 101a, 101b, and 101c.

The laser lights emitted from the laser light sources 101a, 101b, and 101c are converted to collimated lights by the collimator lenses 103a to 103c, respectively. The laser lights that have passed through the collimator lenses 103a to 103c are shaped into beams each having a shape (rectangular shape) that is the shape of a modulation region of the spatial light modulator 108, by the apertures 104a to 104c, respectively. That is, the apertures 104a to 104c form a beam shaping part for matching the beam sizes and the beam shapes of the laser lights emitted from the laser light sources 101a, 101b, and 101c, respectively, with each other.

Instead of the collimator lenses 103a to 103c, shaping lenses for shaping the laser lights into beams each having a shape (rectangular shape) that is the shape of the modulation region of the spatial light modulator 108 and converting the laser lights to collimated lights may be used. In this case, the apertures 104a to 104c can be omitted.

Thereafter, the optical axes of the laser lights of the respective colors emitted from the laser light sources 101a, 101b, and 101c are caused to coincide with each other by the mirror 105 and the two dichroic mirrors 106a and 106b. The mirror 105 substantially totally reflects the red laser light that has passed through the collimator lens 103a. The dichroic mirror 106a reflects the green laser light that has passed through the collimator lens 103b, and transmits the red laser light reflected by the mirror 105. The dichroic mirror 106b transmits the blue laser light that has passed through the collimator lens 103c, and reflects the red laser light and the green laser light that have passed through the dichroic mirror 106a. The mirror 105 and the two dichroic mirrors 106a and 106b are placed such that the optical axes of the laser lights of the respective colors emitted from the laser light sources 101a, 101b, and 101c are caused to coincide with each other.

The laser light sources 101a, 101b, and 101c are placed such that the polarization direction of the laser light of each color incident on the polarizing beam splitter 107 is an S-polarization direction.

The polarizing beam splitter 107 includes a polarizing surface 107a which reflects S-polarized light and allows P-polarized light to pass therethrough. The laser light of each color that has passed through the dichroic mirror 106b is reflected by the polarizing surface 107a of the polarizing beam splitter 107 and guided to the spatial light modulator 108.

The spatial light modulator 108 is composed of, for example, LCOS (Liquid Crystal On Silicon). The spatial light modulator 108 modulates the light of each color reflected by the polarizing surface 107a, according to a driving signal, and generates display light that is the source of the image 30. At this time, a rotation angle in a polarization direction of the laser light of each color is adjusted for each pixel to an angle corresponding to the luminance of the pixel. Accordingly, as for the laser light of each color from the spatial light modulator 108 toward the polarizing beam splitter 107, the amount of the laser light passing through the polarizing surface 107a is adjusted for each pixel. Thus, display light corresponding to a rendered image is generated by the P-polarized laser light of each color passing through the polarizing surface 107a.

The half-wave plate 109 changes the polarization direction of the display light incident from the polarizing beam splitter 107. An actuator 109a rotates the half-wave plate 109 around an optical axis. Specifically, the actuator 109a changes the rotation position of the half-wave plate 109 to two positions in response to a drive signal. Accordingly, the display light that has passed through the half-wave plate 109 is set to a first polarization direction or a second polarization direction. For example, the second polarization direction is a direction rotated by 90° relative to the first polarization direction. Thus, the display light whose polarization direction is set by the half-wave plate 109 is incident on the hologram light guide plate 22.

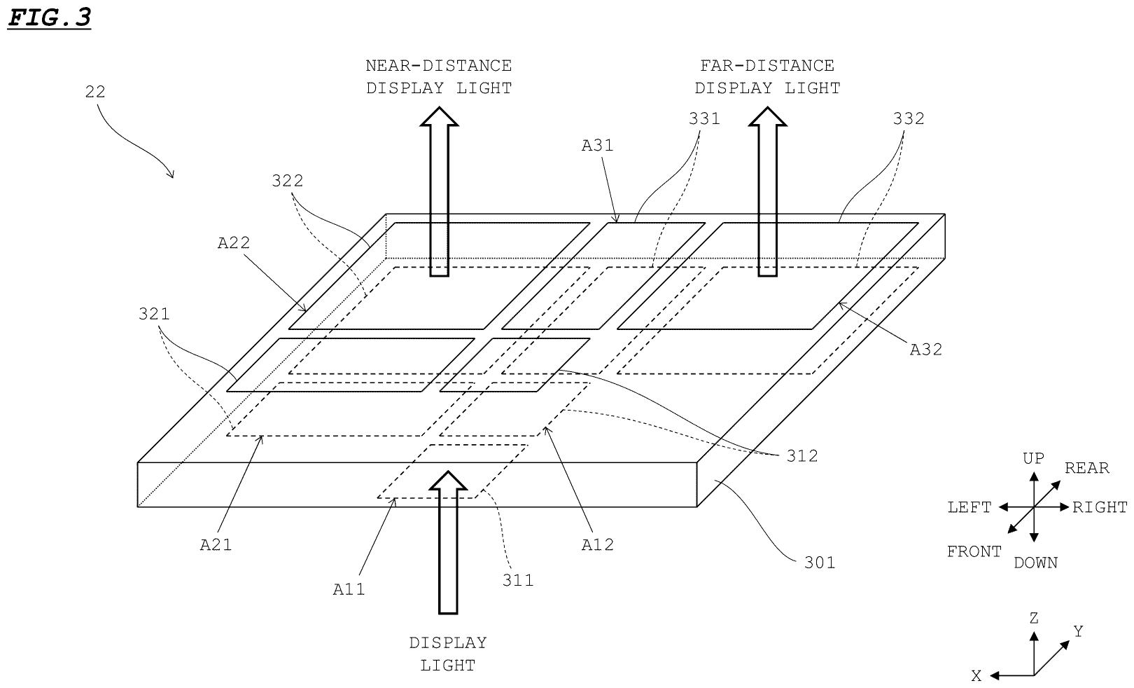

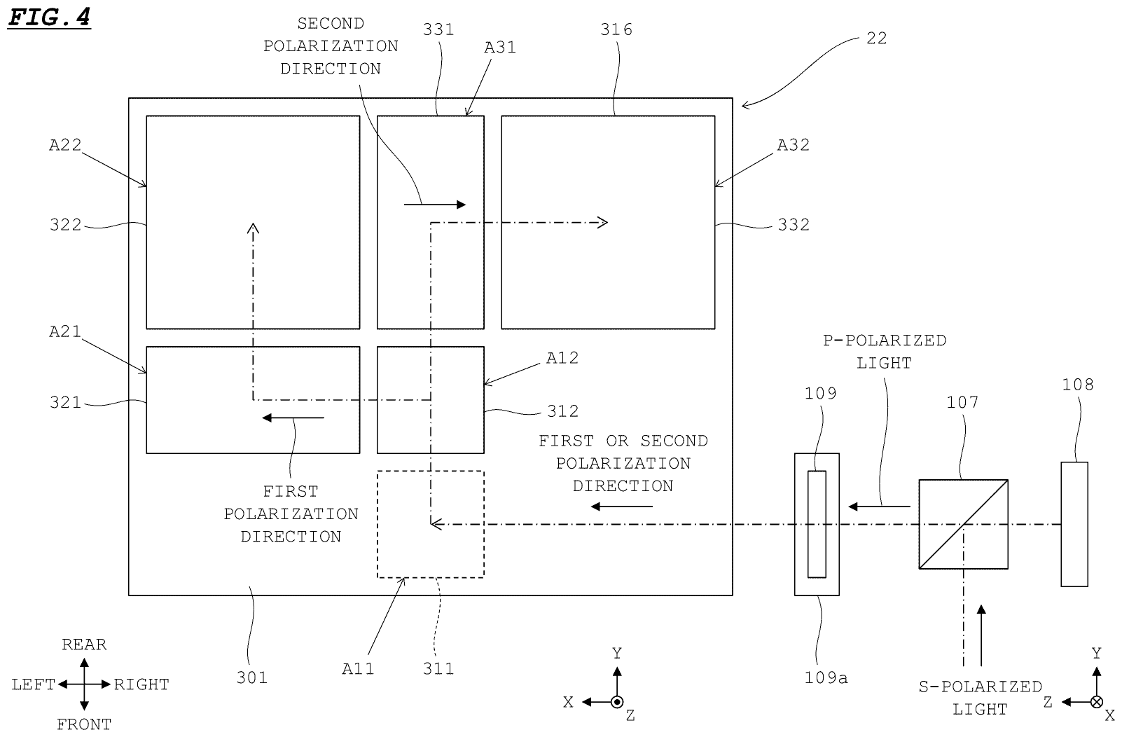

In the hologram light guide plate 22, polarization-dependent holograms are formed in a plurality of regions. The hologram light guide plate 22 emits the display light having the first polarization direction and the display light having the second polarization direction, which are incident from the half-wave plate 109 side, from different emission regions, respectively, by the holograms of these regions. The display lights emitted from the hologram light guide plate 22 are applied to the windshield 12 (see FIG. 1A to FIG. 1C). A configuration of the hologram light guide plate 22 will be described later with reference to FIG. 3 and FIG. 4.

An image control circuit 201 includes an arithmetic processing unit such as a CPU and an FPGA, and a memory. The image control circuit 201 processes an inputted image signal and controls a laser drive circuit 202, a display drive circuit 203, and an actuator drive circuit 204. In addition, based on the detection result of the temperature sensor 102, the image control circuit 201 controls the emission power of the light source 101 via the laser drive circuit 202 and sets the brightness of the display light such that a decrease in the luminance of the image 30 (see FIG. 1C) is suppressed.

The laser drive circuit 202 drives the laser light sources 101a, 101b, and 101c in response to control signals inputted from the image control circuit 201. The display driving circuit 203 drives the spatial light modulator 108 in response to a control signal inputted from the image control circuit 201. The actuator drive circuit 204 drives the actuator 109a in response to a control signal inputted from the image control circuit 201.

Next, the configuration of the hologram light guide plate 22 will be described with reference to FIG. 3 and FIG. 4.

FIG. 3 is a perspective view schematically showing the configuration of the hologram light guide plate 22. In FIG. 3, for convenience, the right-left direction, the front-rear direction, and the up-down direction correspond to the respective directions of the X, Y, and Z axes in the hologram light guide plate 22.

The hologram light guide plate 22 includes a light guide path 301, one hologram 311, a pair of holograms 312, a pair of holograms 321, a pair of holograms 322, a pair of holograms 331, and a pair of holograms 332. The hologram light guide plate 22 is provided with an incident region A11, a distribution region A12, a propagation region A21, a first emission region A22, a propagation region A31, and a second emission region A32.

The light guide path 301 is composed of a transparent flat glass plate. The light guide path 301 may be composed of a transparent flat plate-shaped resin instead of a glass plate.

The hologram 311 is installed on the lower surface of the light guide path 301 at a front end center thereof. The pair of holograms 312 are installed on the upper surface and the lower surface of the light guide path 301 adjacent to the rear of the hologram 311, and are installed at the same position in a plan view. The pair of holograms 321 are installed on the upper surface and the lower surface of the light guide path 301 adjacent to the left of the pair of holograms 312, and are installed at the same position in a plan view. The pair of holograms 322 are installed on the upper surface and the lower surface of the light guide path 301 adjacent to the rear of the pair of holograms 321, and are installed at the same position in a plan view. The pair of holograms 331 are installed on the upper surface and the lower surface of the light guide path 301 adjacent to the rear of the pair of holograms 312, and are installed at the same position in a plan view. The pair of holograms 332 are installed on the upper surface and the lower surface of the light guide path 301 adjacent to the right of the pair of holograms 331, and are installed at the same position in a plan view.

The hologram 311 has a square shape. The pair of holograms 312 each have a square shape and have the same size as the hologram 311. The pair of holograms 321 each have a length in a short side direction thereof (front-rear direction) equal to the length of one side of the hologram 312. The pair of holograms 322 each have a square shape, and the length of one side thereof is equal to the length in a long side direction (right-left direction) of the hologram 321. The pair of holograms 331 each have a length in a short side direction thereof (right-left direction) equal to the length of one side of the hologram 312 and have a length in a long side direction thereof (front-rear direction) equal to the length of one side of the hologram 322. The pair of holograms 332 each have a square shape and have the same size as the hologram 322.

The incident region A11 includes the hologram 311, and the light guide path 301 at the position of the hologram 311. The distribution region A12 includes the pair of holograms 312, and the light guide path 301 between the pair of holograms 312. The propagation region A21 includes the pair of holograms 321, and the light guide path 301 between the pair of holograms 321. The first emission region A22 includes the pair of holograms 322, and the light guide path 301 between the pair of holograms 322. The propagation region A31 includes the pair of holograms 331, and the light guide path 301 between the pair of holograms 331. The second emission region A32 includes the pair of holograms 332, and the light guide path 301 between the pair of holograms 332. The display light from the half-wave plate 109 is incident on the incident region A11 in the upward direction.

FIG. 4 is a plan view schematically showing the configuration of the hologram light guide plate 22. For convenience, FIG. 4 shows the polarizing beam splitter 107, the spatial light modulator 108, and the half-wave plate 109, which are located below the hologram light guide plate 22 (in the Z-axis negative direction), as seen in the X-axis positive direction.

The hologram 311 is configured to diffract the display light having the first polarization direction and the display light having the second polarization direction toward the rear side. Accordingly, the incident region A11 causes the display light incident from the half-wave plate 109 to propagate to the distribution region A12.

The pair of holograms 312 are configured such that the diffraction efficiency in the first polarization direction thereof is the highest and the diffraction efficiency in the second polarization direction thereof is the lowest. The diffraction direction of the pair of holograms 312 is the left direction. Accordingly, the distribution region A12 causes the display light having the first polarization direction out of the display lights from the incident region A11 to propagate to the propagation region A21, and causes the display light having the second polarization direction out of the display lights from the incident region A11 to propagate to the propagation region A31. In addition, the pair of holograms 312 are configured to diffuse the display light having the first polarization direction and travelling toward the propagation region A21, in the right-left direction, and diffuse the display light having the second polarization direction and travelling toward the propagation region A31, in the front-rear direction.

The pair of holograms 321 are configured such that the diffraction efficiency in the first polarization direction thereof is the highest. The diffraction direction of the pair of holograms 321 is the rear direction. Accordingly, the propagation region A21 causes the display light having the first polarization direction and travelling from the distribution region A12 to propagate to the first emission region A22. In addition, the pair of holograms 321 are configured to diffuse the display light having the first polarization direction and travelling toward the first emission region A22, in the front-rear direction.

The pair of holograms 322 are configured such that the diffraction efficiency in the first polarization direction thereof is the highest and the display light having the first polarization direction and travelling from the propagation region A21 is emitted from the entirety of the first emission region A22. Accordingly, the first emission region A22 emits the display light having the first polarization direction and travelling from the propagation region A21, from the hologram light guide plate 22 in the Z-axis positive direction to guide this display light to the projection region 13 (see FIG. 1B).

A diffraction pattern formed in each hologram 322 has a lens effect of causing the display light emitted from the first emission region A22 to form an image at a near distance. Accordingly, the display light emitted from the first emission region A22 is applied as near-distance display light to the projection region 13 to form an image corresponding to the near distance.

The pair of holograms 331 are configured such that the diffraction efficiency in the second polarization direction thereof is the highest. The diffraction direction of the pair of holograms 331 is the right direction. Accordingly, the propagation region A31 causes the display light having the second polarization direction and travelling from the distribution region A12 to propagate to the second emission region A32. In addition, the pair of holograms 331 are configured to diffuse the display light having the second polarization direction and travelling toward the second emission region A32, in the right-left direction.

The pair of holograms 332 are configured such that the diffraction efficiency in the second polarization direction thereof is the highest and the display light having the second polarization direction and travelling from the propagation region A31 is emitted from the entirety of the second emission region A32. Accordingly, the second emission region A32 emits the display light having the second polarization direction and travelling from the propagation region A31, from the hologram light guide plate 22 in the Z-axis positive direction to guide this display light to the projection region 13 (see FIG. 1B).

A diffraction pattern formed in each hologram 332 has a lens effect of causing the display light emitted from the second emission region A32 to form an image at a far distance. Accordingly, the display light emitted from the second emission region A32 is applied as far-distance display light to the projection region 13 to form an image corresponding to the far distance.

In the case where an optical system such as a lens is further placed between the hologram light guide plate 22 and the windshield 12, a diffraction pattern that, together with the optical action of this optical system, causes the display light to form an image at a predetermined distance position may be set for each of the holograms 322 and 332.

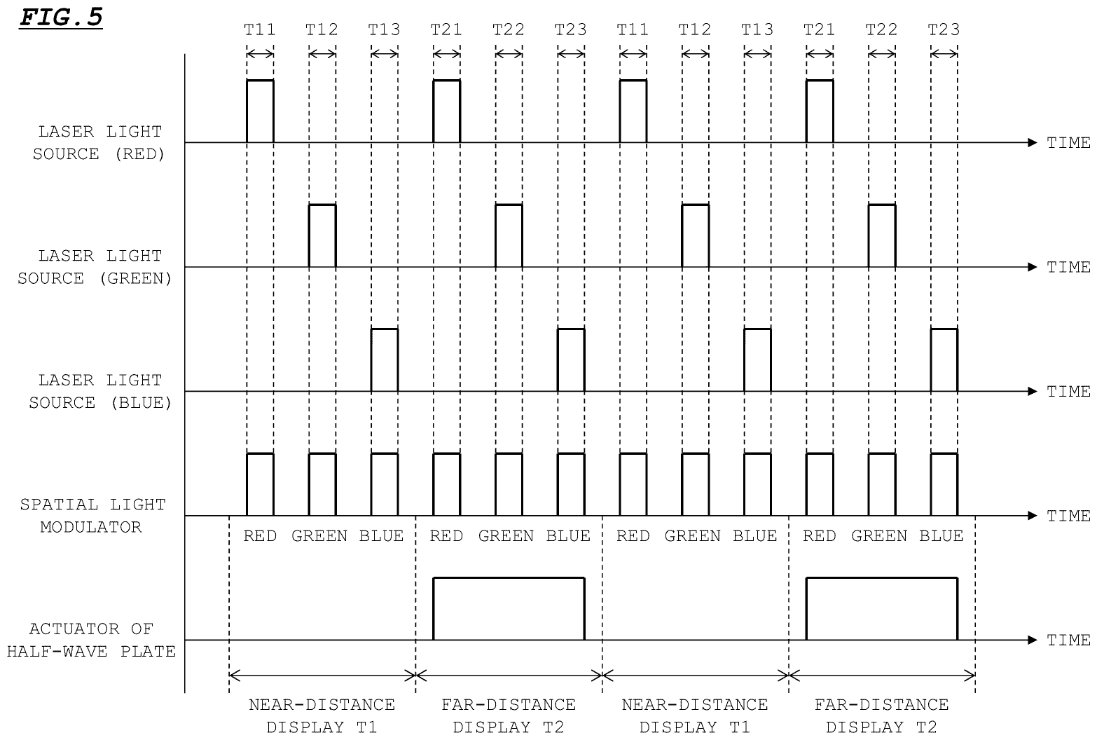

FIG. 5 is a timing chart schematically showing driving of the laser light sources 101a, 101b, and 101c, the spatial light modulator 108, and the actuator 109a of the half-wave plate 109.

The image control circuit 201 alternately and repeatedly sets a near-distance display period T1 in which the near-distance display light is emitted from the first emission region A22 and a far-distance display period T2 in which the far-distance display light is emitted from the second emission region A32.

In the near-distance display period T1, the image control circuit 201 controls the actuator 109a via the actuator drive circuit 204 to set the half-wave plate 109 at a first position. The first position is a position at which the direction of the display light having passed through the half-wave plate 109 is the first polarization direction. In the near-distance display period T1, the image control circuit 201 controls the laser light sources 101a, 101b, and 101c via the laser drive circuit 202 to emit red laser light in a period T11, emit green laser light in a period T12, and emit blue laser light in a period T13. The image control circuit 201 controls the spatial light modulator 108 via the display drive circuit 203 to modulate the red laser light, the green laser light, and the blue laser light in the periods T11, T12, and T13, respectively.

Accordingly, in the near-distance display period T1, display light based on the red laser light having the first polarization direction, display light based on the green laser light having the first polarization direction, and display light based on the blue laser light having the first polarization direction form a near-distance image, for one frame, corresponding to the near distance.

In the far-distance display period T2, the image control circuit 201 controls the actuator 109a via the actuator drive circuit 204 to set the half-wave plate 109 at a second position. The second position is a position at which the direction of the display light having passed through the half-wave plate 109 is the second polarization direction. In the far-distance display period T2, the image control circuit 201 controls the laser light sources 101a, 101b, and 101c via the laser drive circuit 202 to emit red laser light in a period T21, emit green laser light in a period T22, and emit blue laser light in a period T23. The image control circuit 201 controls the spatial light modulator 108 via the display drive circuit 203 to modulate the red laser light, the green laser light, and the blue laser light in the periods T21, T22, and T23, respectively.

Accordingly, in the far-distance display period T2, display light based on the red laser light having the second polarization direction, display light based on the green laser light having the second polarization direction, and display light based on the blue laser light having the second polarization direction form a far-distance image, for one frame, corresponding to the far distance.

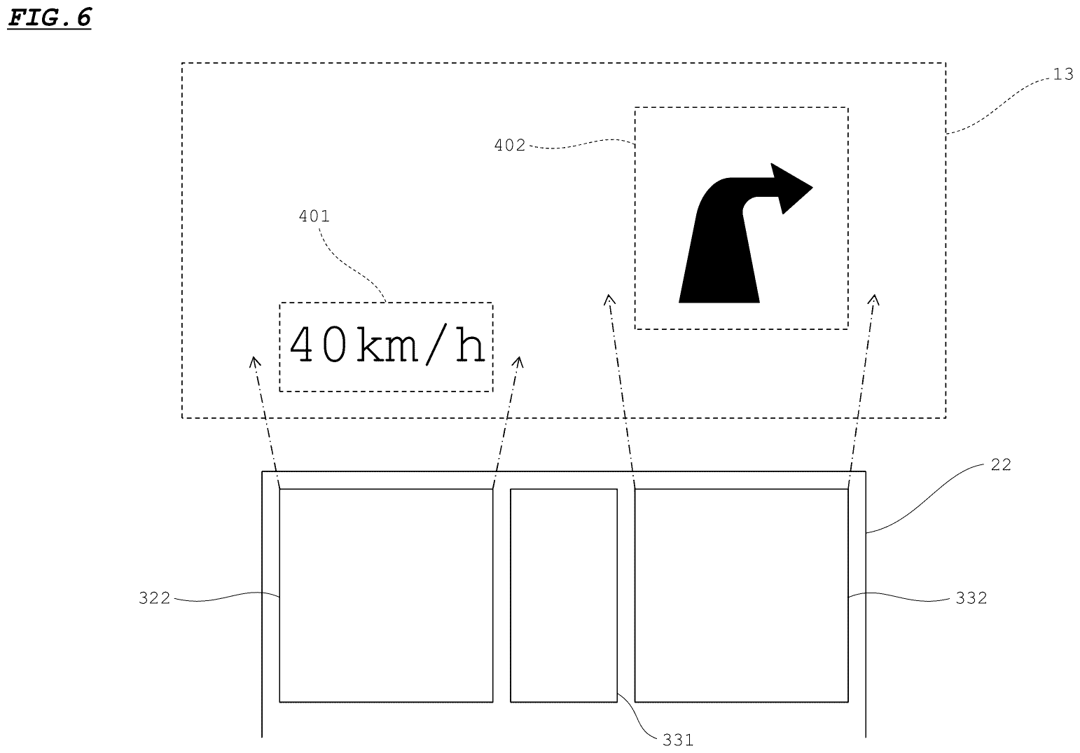

FIG. 6 is a diagram schematically showing a near-distance image 401 and a far-distance image 402 which are virtual images formed in a space in front of the projection region 13.

The near-distance image 401 and the far-distance image 402 are displayed as virtual images at a position farther than the projection region 13 as seen from the driver 2. The near-distance image 401 indicates the speed of the passenger car 1 at a position closer to the projection region 13. The far-distance image 402 indicates the direction in which the passenger car 1 is to travel next, along the surface of a road at a position farther from the projection region 13. Accordingly, the driver 2 can check the speed and the travelling direction while keeping their line of sight on the road conditions ahead, without having to look down to see the display of a speedometer and the display of a car navigation system installed inside the dashboard 11.

### <Effects of Embodiment 1>

According to the present embodiment, the following effects are achieved.

The display light generator 21 causes two types of display light having different polarization directions from each other to be incident on the incident region A11 of the hologram light guide plate 22. The first emission region A22 has the holograms 322 for causing the display light having the first polarization direction (first type) to form an image, and the second emission region A32 has the holograms 332 for causing the display light having the second polarization direction (second type) to form an image. The distribution region A12 has the polarization-dependent holograms 312, and guides the display light having the first polarization direction (first type) and the display light having the second polarization direction (second type), out of the two types of display light incident from the incident region A11, to the first emission region A22 and the second emission region A32, respectively.

With this configuration, when the display light having the first polarization direction is incident from the incident region A11, the display light is guided to the first emission region A22 by the distribution region A12, and when the display light having the second polarization direction is incident from the incident region A11, the display light is guided to the second emission region A32 by the distribution region A12. Therefore, the utilization efficiency of the display light having each polarization direction can be increased. When the utilization efficiency of the display light is increased, output to the light source 101 can be suppressed, so that heat generation, deterioration, power consumption, etc., of the laser light sources 101a, 101b, and 101c can be suppressed.

Such distribution of display light can be realized simply by placing the distribution region A12, which has the polarization-dependent holograms 312, in the hologram light guide plate 22. Thus, complication and size increase of the hologram light guide plate 22 can be suppressed, resulting in simplification and cost reduction of the image display device 20.

The first type of display light generated in the display light generator 21 has the first polarization direction, and the second type of display light generated in the display light generator 21 has the second polarization direction. With this configuration, the two types of display light can be smoothly guided to the first emission region A22 and the second emission region A32, respectively, by utilizing the difference in polarization direction of the display light.

The display light generator 21 includes the half-wave plate 109 (optical element) for switching the polarization direction of the display light from the polarizing beam splitter 107 between the first polarization direction and the second polarization direction. With this configuration, two types of display light having different polarization directions from each other can be generated by a simple configuration.

The half-wave plate 109 includes the actuator 109a for rotating the half-wave plate 109 around the optical axis. With this configuration, two types of display light having different polarization directions from each other can be easily generated by rotating the half-wave plate 109 around the optical axis by the actuator 109a.

The holograms 312 of the distribution region A12 are configured such that the diffraction efficiency in the first polarization direction thereof is the highest and the diffraction efficiency in the second polarization direction thereof is the lowest. With this configuration, the display light having the first polarization direction and the display light having the second polarization direction can be efficiently guided to the first emission region A22 and the second emission region A32, respectively.

The holograms 322 of the first emission region A22 are configured such that the diffraction efficiency in the first polarization direction thereof is the highest, and the holograms 332 of the second emission region A32 are configured such that the diffraction efficiency in the second polarization direction thereof is the highest. With this configuration, the display light having the first polarization direction and the display light having the second polarization direction can be efficiently emitted from the first emission region A22 and the second emission region A32, respectively.

The first emission region A22 and the second emission region A32 cause the display light having the first polarization direction and the display light having the second polarization direction to form images at positions different from each other. With this configuration, a plurality of types of images can be displayed. In addition, by setting the holograms of the first emission region A22 and the second emission region A32 such that the distances to the image formation positions of the respective display lights are different, a plurality of types of images with different viewing distances can be displayed. Accordingly, the speed of the passenger car 1 is displayed by the near-distance image 401 so as to be easily seen, and a travelling direction along a road is displayed by the far-distance image 402 so as to be easily seen.

### Modification 1

In Embodiment 1, the holograms 322 and 332 of the first emission region A22 and the second emission region A32 are configured to cause the display light to form images at different viewing distance positions, but may be configured to cause the display light to form images at the same viewing distance position. For example, similar to the first emission region A22, the second emission region A32 may have a diffraction action of causing display light to form an image at a near distance.

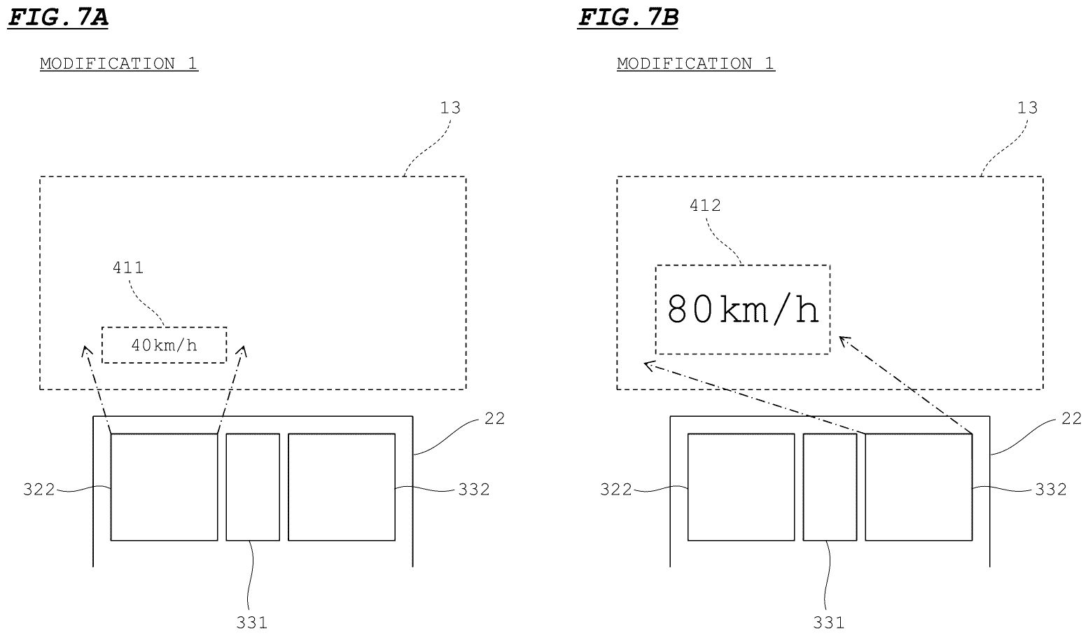

FIG. 7A is a diagram schematically showing a near-distance image 411 which is a virtual image formed in the space in front of the projection region 13 according to Modification 1.

In Modification 1, as in Embodiment 1, the near-distance image 411 showing the speed of the passenger car 1 is displayed based on the near-distance display light emitted from the first emission region A22. However, in Modification 1, a process of generating the near-distance image 411 is also executed in the far-distance display period T2 in FIG. 5. Accordingly, the display in FIG. 7A is basically performed.

FIG. 7B is a diagram schematically showing a near-distance image 412 which is a virtual image formed in the space in front of the projection region 13 according to Modification 1.

In Modification 1, the image control circuit 201 determines whether or not the speed of the passenger car 1 has exceeded a certain speed (e.g., whether or not the speed is 80 km/h or more), based on a speed signal from the passenger car 1. If the speed of the passenger car 1 has exceeded the certain speed, the image control circuit 201 changes the display of the near-distance image 411 and displays the near-distance image 412 showing the speed of the passenger car 1, based on the near-distance display light emitted from the second emission region A32. In Modification 1, since, as in the first emission region A22, the holograms 332 of the second emission region A32 have a diffraction action of causing the display light to form an image at a near distance, the near-distance images 411 and 412 are images formed at the same near distance as each other. In addition, the holograms 332 of the second emission region A32 are configured such that the near-distance image 412 is larger than the near-distance image 411.

In Modification 1, as in Embodiment 1, the driver 2 can always check the speed of the passenger car 1 by the near-distance image 411 during normal operation. In addition, the driver 2 can check the speed of the passenger car 1 on a large display by the near-distance image 412 upon overspeeding, so that the driver 2 can reliably grasp such overspeeding.

In the near-distance image 412, not only the specific speed is displayed, but also a text or icon indicating that overspeeding has occurred may be displayed. In addition, the near-distance image 412 may be displayed in a color suitable for warning indication, such as red. The near-distance image 412 is not limited to be being displayed at the same position as the near-distance image 411, but may be displayed at a position different from that of the near-distance image 411.

### Modification 2

In Modification 1, the near-distance image 411 is displayed during normal operation, and the near-distance image 412 is displayed instead of the near-distance image 411 upon overspeeding, but when a predetermined condition has been satisfied, two near-distance images may be displayed simultaneously.

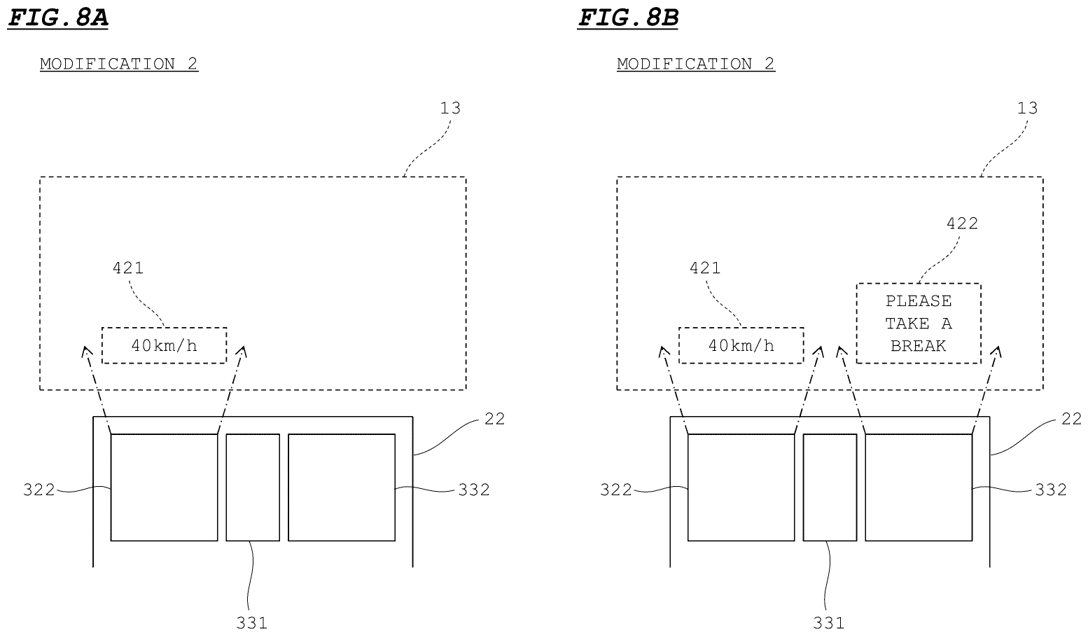

FIG. 8A is a diagram schematically showing a near-distance image 421 which is a virtual image formed in the space in front of the projection region 13 according to Modification 2. In Modification 2, the near-distance image 421 which is similar to the near-distance image 411 in Modification 1 is always displayed.

FIG. 8B is a diagram schematically showing near-distance images 421 and 422 which are virtual images formed in the space in front of the projection region 13 according to Modification 2.

In Modification 2, the image control circuit 201 determines whether or not a predetermined condition has been satisfied, based on various signals from the passenger car 1. The predetermined condition is, for example, that drowsiness of the driver 2 has been detected from an image by an in-vehicle camera, etc., that the driving duration of the passenger car 1 has exceeded a predetermined time, or the like. When drowsiness of the driver 2 has been detected, or when the driving duration of the passenger car 1 has exceeded the predetermined time, the image control circuit 201 displays the near-distance image 422 indicating that the predetermined condition has been satisfied, in addition to the near-distance image 421.

In the example in FIG. 8B, a message urging the driver 2 to take a rest is shown as the near-distance image 422 displayed when drowsiness of the driver 2 is detected. In Modification 2, the second emission region A32 is configured such that the near-distance image 422 is as large as the near-distance image 421.

In Modification 2, the driver 2 can always check the speed of the passenger car 1 by the near-distance image 421. In addition, when the predetermined condition has been satisfied, such as when drowsiness has been detected or when the driving duration has exceeded the predetermined time, the driver 2 can confirm that the predetermined condition has been satisfied, by the near-distance image 422, which can be useful for safe driving.

### Embodiment 2

In Embodiment 1, in accordance with the polarization direction of the display light, the display light having the first polarization direction is emitted from the first emission region A22, and the display light having the second polarization direction is emitted from the second emission region A32. In contrast, in Embodiment 2, in accordance with the wavelength of the display light, display light that is red laser light is emitted from a first emission region A52, display light that is green laser light is emitted from a second emission region A62, and display light that is blue laser light is emitted from a third emission region A72. In the hologram light guide plate 22 of Embodiment 2, wavelength-dependent holograms are formed in a plurality of regions.

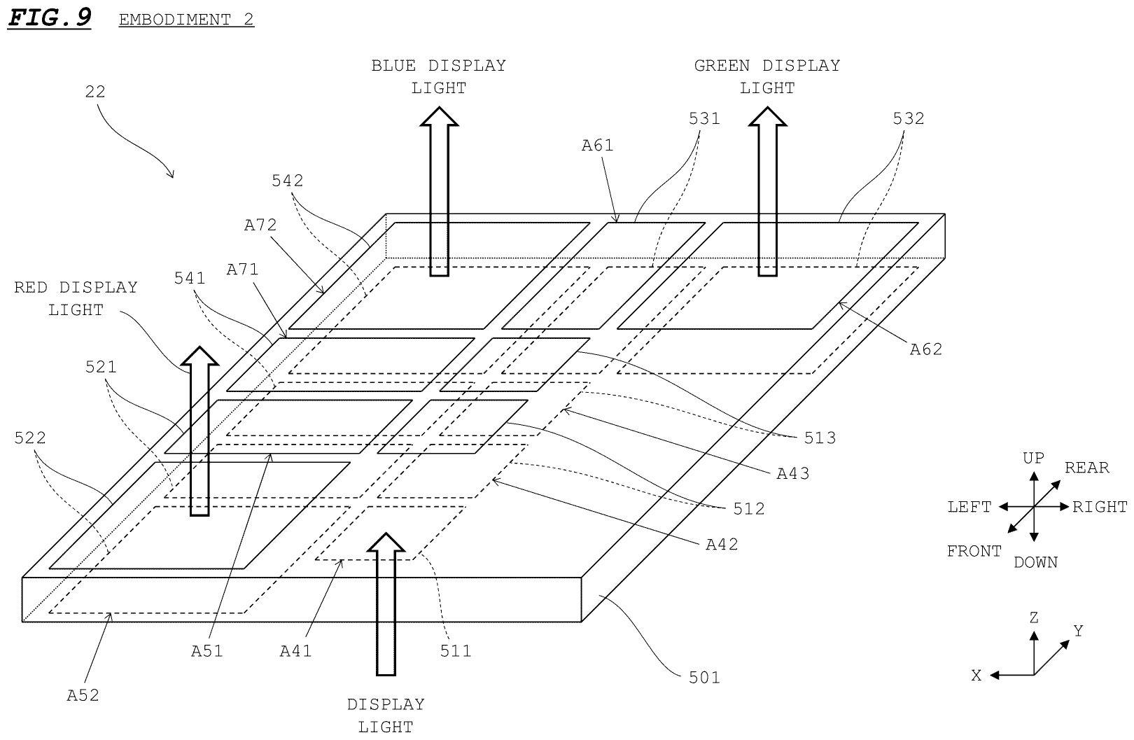

FIG. 9 is a perspective view schematically showing a configuration of the hologram light guide plate 22 according to Embodiment 2.

The hologram light guide plate 22 of the Embodiment 2 includes a light guide path 501, one hologram 511, a pair of holograms 512, a pair of holograms 513, a pair of holograms 521, a pair of holograms 522, a pair of holograms 531, a pair of holograms 532, a pair of holograms 541, and a pair of holograms 542. The hologram light guide plate 22 is provided with an incident region A41, a distribution region A42, a distribution region A43, a propagation region A51, the first emission region A52, a propagation region A61, the second emission region A62, a propagation region A71, and the third emission region A72.

The light guide path 501 is composed of a transparent flat glass plate. The light guide path 501 may be composed of a transparent flat plate-shaped resin instead of a glass plate.

The hologram 511 is installed on the lower surface of the light guide path 501 near the front end and at the center thereof. The pair of holograms 512 are installed on the upper surface and the lower surface of the light guide path 501 adjacent to the rear of the hologram 511, and are installed at the same position in a plan view. The pair of holograms 513 are installed on the upper surface and the lower surface of the light guide path 501 adjacent to the rear of the holograms 512, and are installed at the same position in a plan view.

The pair of holograms 521 are installed on the upper surface and the lower surface of the light guide path 501 adjacent to the left of the pair of holograms 512, and are installed at the same position in a plan view. The pair of holograms 522 are installed on the upper surface and the lower surface of the light guide path 501 adjacent to the front of the pair of holograms 521, and are installed at the same position in a plan view. The pair of holograms 531 are installed on the upper surface and the lower surface of the light guide path 501 adjacent to the rear of the pair of holograms 513, and are installed at the same position in a plan view. The pair of holograms 532 are installed on the upper surface and the lower surface of the light guide path 501 adjacent to the right of the pair of holograms 531, and are installed at the same position in a plan view. The pair of holograms 541 are installed on the upper surface and the lower surface of the light guide path 501 adjacent to the left of the pair of holograms 513, and are installed at the same position in a plan view. The pair of holograms 542 are installed on the upper surface and the lower surface of the light guide path 501 adjacent to the rear of the pair of holograms 541, and are installed at the same position in a plan view.

The hologram 511 has a square shape. The pairs of holograms 512 and 513 each have a square shape and have the same size as the hologram 511. The pair of holograms 521 each have a length in a short side direction thereof (front-rear direction) equal to the length of one side of the hologram 512. The pair of holograms 522 each have a square shape, and the length of one side thereof is equal to the length in a long side direction (right-left direction) of the hologram 521. The pair of holograms 531 each have a length in a short side direction thereof (right-left direction) equal to the length of one side of the hologram 513 and have a length in a long side direction thereof (front-rear direction) equal to the length of one side of the hologram 522. The pair of holograms 532 each have a square shape and have the same size as the hologram 522. The pair of holograms 541 each have a length in a short side direction thereof (front-rear direction) equal to the length of one side of the hologram 513 and have a length in a long side direction thereof (right-left direction) equal to the length of one side of the hologram 522. The pair of holograms 542 each have a square shape and have the same size as the hologram 522.

The incident region A41 includes the hologram 511, and the light guide path 501 at the position of the hologram 511. The distribution region A42 includes the pair of holograms 512, and the light guide path 501 between the pair of holograms 512. The distribution region A43 includes the pair of holograms 513, and the light guide path 501 between the pair of holograms 513.

The propagation region A51 includes the pair of holograms 521, and the light guide path 501 between the pair of holograms 521. The first emission region A52 includes the pair of holograms 522, and the light guide path 501 between the pair of holograms 522. The propagation region A61 includes the pair of holograms 531, and the light guide path 501 between the pair of holograms 531. The second emission region A62 includes the pair of holograms 532, and the light guide path 501 between the pair of holograms 532. The propagation region A71 includes the pair of holograms 541, and the light guide path 501 between the pair of holograms 541. The third emission region A72 includes the pair of holograms 542, and the light guide path 501 between the pair of holograms 542.

In Embodiment 2, the half-wave plate 109 is omitted as compared to Embodiment 1. The display light from the polarizing beam splitter 107 is incident on the incident region A41 in the upward direction.

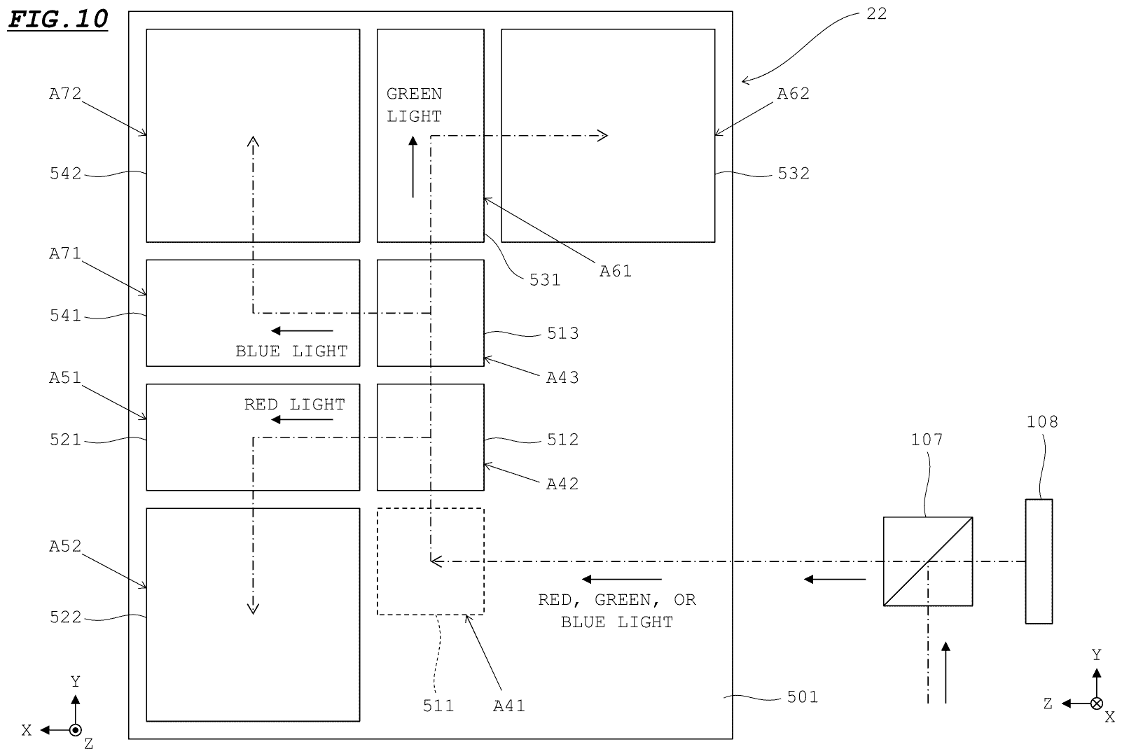

FIG. 10 is a plan view schematically showing the configuration of the hologram light guide plate 22 according to Embodiment 2. For convenience, FIG. 10 shows the polarizing beam splitter 107 and the spatial light modulator 108, which are located below the hologram light guide plate 22 (in the Z-axis negative direction), as seen in the X-axis positive direction.

In Embodiment 2, display lights having a red wavelength, a green wavelength, and a blue wavelength (red laser light, green laser light, and blue laser light) that have passed through the polarizing beam splitter 107 are incident on the hologram light guide plate 22 in the Z-axis positive direction, that is, the upward direction, from the lower surface of the hologram 511 of the incident region A41.

The hologram 511 is configured to diffract the display light having the red wavelength, the display light having the green wavelength, and the display light having the blue wavelength toward the rear side. Accordingly, the incident region A41 causes the display lights incident from the polarizing beam splitter 107 to propagate to the distribution region A42.

The pair of holograms 512 are configured such that the diffraction efficiency at the red wavelength thereof is the highest, and the diffraction efficiency at the green wavelength and the blue wavelength thereof is the lowest. The diffraction direction of the pair of holograms 512 is the left direction. Accordingly, the distribution region A42 causes the display light having the red wavelength out of the display lights from the incident region A41 to propagate to the propagation region A51, and causes the display lights having the green wavelength and the blue wavelength out of the display lights from the incident region A41 to propagate to the distribution region A43. In addition, the pair of holograms 512 are configured to diffuse the display light having the red wavelength and travelling toward the propagation region A51, in the right-left direction.

The pair of holograms 521 are configured such that the diffraction efficiency at the red wavelength thereof is the highest. The diffraction direction of the pair of holograms 521 is the front direction. Accordingly, the propagation region A51 causes the display light having the red wavelength and travelling from the distribution region A42 to propagate to the first emission region A52. In addition, the pair of holograms 521 are configured to diffuse the display light having the red wavelength and travelling toward the first emission region A52, in the front-rear direction.

The pair of holograms 522 are configured such that the diffraction efficiency at the red wavelength thereof is the highest and the display light having the red wavelength and travelling from the propagation region A51 is emitted from the entirety of the first emission region A52. Accordingly, the first emission region A52 emits the display light having the red wavelength and travelling from the propagation region A51, from the hologram light guide plate 22 in the Z-axis positive direction to guide this display light to the projection region 13 (see FIG. 1B).

A diffraction pattern formed in each hologram 522 has a lens effect of causing the display light emitted from the first emission region A52 to form an image at a near distance. Accordingly, the display light emitted from the first emission region A52 is applied as near-distance display light to the projection region 13 to form an image corresponding to the near distance.

The pair of holograms 513 are configured such that the diffraction efficiency at the blue wavelength thereof is the highest and the diffraction efficiency at the green wavelength thereof is the lowest. The diffraction direction of the pair of holograms 513 is the left direction. Accordingly, the distribution region A43 causes the display light having the blue wavelength out of the display lights from the incident region A41 to propagate to the propagation region A71, and causes the display light having the green wavelength out of the display lights from the incident region A41 to propagate to the propagation region A61. In addition, the pair of holograms 513 are configured to diffuse the display light having the blue wavelength and travelling toward the propagation region A71, in the right-left direction.

The pair of holograms 531 are configured such that the diffraction efficiency at the green wavelength thereof is the highest. The diffraction direction of the pair of holograms 531 is the right direction. Accordingly, the propagation region A61 causes the display light having the green wavelength and travelling from the distribution region A43 to propagate to the second emission region A62. In addition, the pair of holograms 531 are configured to diffuse the display light having the green wavelength and travelling toward the second emission region A62, in the right-left direction.

The pair of holograms 532 are configured such that the diffraction efficiency at the green wavelength thereof is the highest and the display light having the green wavelength and travelling from the propagation region A61 is emitted from the entirety of the second emission region A62. Accordingly, the second emission region A62 emits the display light having the green wavelength and travelling from the propagation region A61, from the hologram light guide plate 22 in the Z-axis positive direction to guide this display light to the projection region 13 (see FIG. 1B).

A diffraction pattern formed in each hologram 532 has a lens effect of causing the display light emitted from the second emission region A62 to form an image at a far distance. Accordingly, the display light emitted from the second emission region A62 is applied as far-distance display light to the projection region 13 to form an image corresponding to the far distance.

The pair of holograms 541 are configured such that the diffraction efficiency at the blue wavelength thereof is the highest. The diffraction direction of the pair of holograms 541 is the rear direction. Accordingly, the propagation region A71 causes the display light having the blue wavelength and travelling from the distribution region A43 to propagate to the third emission region A72. In addition, the pair of holograms 541 are configured to diffuse the display light having the blue wavelength and travelling toward the third emission region A72, in the front-rear direction.

The pair of holograms 542 are configured such that the diffraction efficiency at the blue wavelength thereof is the highest and the display light having the blue wavelength and travelling from the propagation region A71 is emitted from the entirety of the third emission region A72. Accordingly, the third emission region A72 emits the display light having the blue wavelength and travelling from the propagation region A71, from the hologram light guide plate 22 in the Z-axis positive direction to guide this display light to the projection region 13 (see FIG. 1B).

A diffraction pattern formed in each hologram 542 has a lens effect of causing the display light emitted from the third emission region A72 to form an image at a near distance. Accordingly, the display light emitted from the third emission region A72 is applied as near-distance display light to the projection region 13 to form an image corresponding to the near distance.

In the case where an optical system such as a lens is further placed between the hologram light guide plate 22 and the windshield 12, a diffraction pattern that, together with the optical action of this optical system, causes the display light to form an image at a predetermined distance position may be set for each of the holograms 522, 532, and 542.

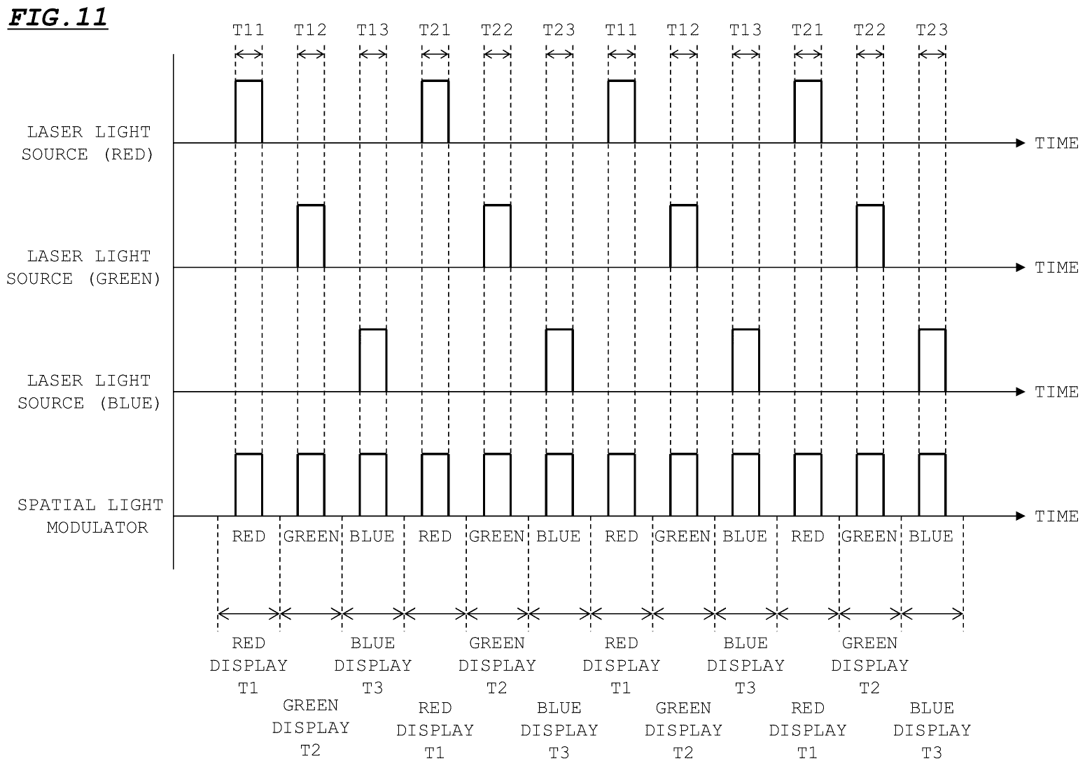

FIG. 11 is a timing chart schematically showing driving of the laser light sources 101a, 101b, and 101c and the spatial light modulator 108.

The image control circuit 201 repeatedly sets a red display period T1 in which the display light having the red wavelength and travelling from the first emission region A52 is emitted, a green display period T2 in which the display light having the green wavelength and travelling from the second emission region A62 is emitted, and a blue display period T3 in which the display light having the blue wavelength and travelling from the third emission region A72 is emitted, in this order.

In the red display period T1, the image control circuit 201 controls the laser light source 101a via the laser drive circuit 202 to emit red laser light in a period T11. The image control circuit 201 controls the spatial light modulator 108 via the display drive circuit 203 to modulate the red laser light in the period T11. Accordingly, in the red display period T1, the display light having the red wavelength forms an image for one frame.

In the green display period T2, the image control circuit 201 controls the laser light source 101b via the laser drive circuit 202 to emit green laser light in a period T12. The image control circuit 201 controls the spatial light modulator 108 via the display drive circuit 203 to modulate the green laser light in the period T12. Accordingly, in the green display period T2, the display light having the green wavelength forms an image for one frame.

In the blue display period T3, the image control circuit 201 controls the laser light source 101c via the laser drive circuit 202 to emit blue laser light in a period T13. The image control circuit 201 controls the spatial light modulator 108 via the display drive circuit 203 to modulate the blue laser light in the period T13. Accordingly, in the blue display period T3, the display light having the blue wavelength forms an image for one frame.

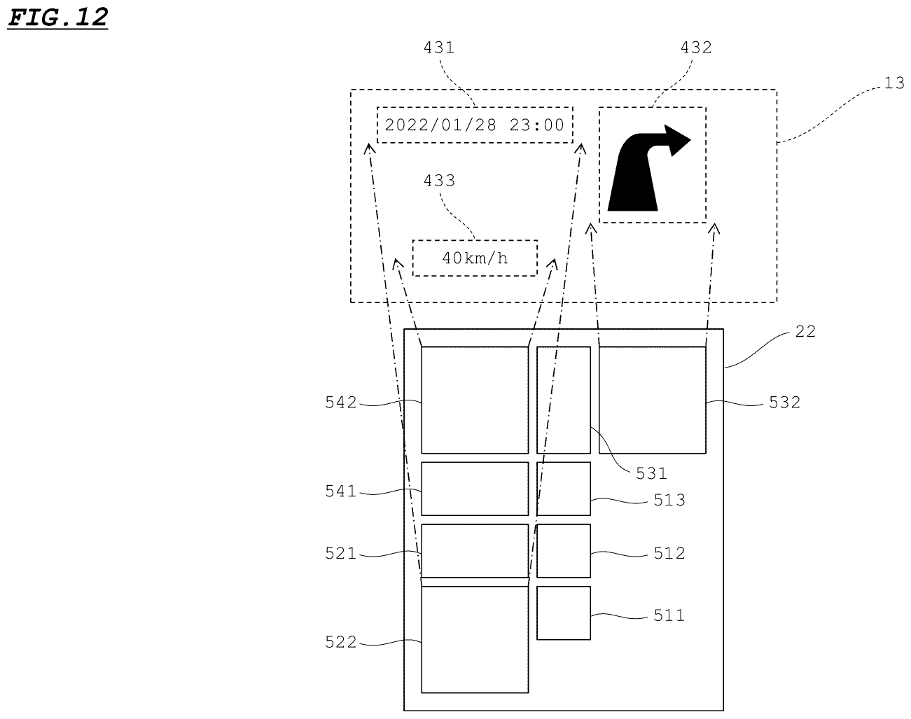

FIG. 12 is a diagram schematically showing near-distance images 431 and 433 and a far-distance image 432 which are virtual images formed in the space in front of the projection region 13.

As in Embodiment 1, the near-distance images 431 and 433 and the far-distance image 432 are displayed as virtual images at a position farther than the projection region 13 as seen from the driver 2. The near-distance images 431 and 433 indicate the speed of the passenger car 1 and the current date and time at a position closer to the projection region 13, respectively. The far-distance image 432 indicates the direction in which the passenger car 1 is to travel next, along the surface of a road at a position farther from the projection region 13. Accordingly, as in Embodiment 1, the driver 2 can check the speed, the travelling direction, and the date and time while keeping their line of sight on the road conditions ahead, without having to look down to see the display of a speedometer and the display of a car navigation system installed inside the dashboard 11.

### <Effects of Embodiment 2>

According to the present embodiment, the following effects are achieved.

The display light generator 21 causes three types of display light having different wavelengths from each other to be incident on the incident region A41 of the hologram light guide plate 22. The first emission region A52 has the holograms 522 for causing the display light having the red wavelength to form an image, the second emission region A62 has the holograms 532 for causing the display light having the green wavelength to form an image, and the third emission region A72 has the holograms 542 for causing the display light having the blue wavelength to form an image. The distribution region A42 has the wavelength-dependent holograms 512, and guides the display light having the red wavelength out of three types of display light incident from the incident region A41, to the first emission region A52. The distribution region A43 has the wavelength-dependent holograms 513, and guides the display light having the green wavelength and the display light having the blue wavelength, out of the three types of display light incident from the incident region A41, to the second emission region A62 and the third emission region A72, respectively.

With this configuration, when the display light having the red wavelength is incident from the incident region A41, the display light is guided to the first emission region A52 by the distribution region A42; when the display light having the green wavelength is incident from the incident region A41, the display light is guided to the second emission region A62 by the distribution region A43; and when the display light having the blue wavelength is incident from the incident region A41, the display light is guided to the third emission region A72 by the distribution region A43. Therefore, as in Embodiment 1, the utilization efficiency of each type of display light can be increased. When the utilization efficiency of the display light is increased, output to the light source 101 can be suppressed, so that heat generation, deterioration, power consumption, etc., of the laser light sources 101a, 101b, and 101c can be suppressed.

Such distribution of display light can be realized simply by placing the distribution regions A42 and A43, which have the holograms 512 and 513 dependent on an optical characteristic, in the hologram light guide plate 22. Thus, complication and size increase of the hologram light guide plate 22 can be suppressed, resulting in simplification and cost reduction of the image display device 20.

The first type of display light generated in the display light generator 21 has the red wavelength, the second type of display light generated in the display light generator 21 has the green wavelength, and the third type of display light generated in the display light generator 21 has the blue wavelength. With this configuration, the three types of display light can be smoothly guided to the first emission region A52, the second emission region A62, and the third emission region A72, respectively, by utilizing the difference in wavelength of the display light.

The holograms 512 of the distribution region A42 are configured such that the diffraction efficiency at the red wavelength thereof is the highest and the diffraction efficiency at the green wavelength and the blue wavelength thereof is the lowest. In addition, the holograms 513 of the distribution region A43 are configured such that the diffraction efficiency at the blue wavelength thereof is the highest and the diffraction efficiency at the green wavelength thereof is the lowest. With this configuration, the display light having the red wavelength, the display light having the green wavelength, and the display light having the blue wavelength can be efficiently guided to the first emission region A52, the second emission region A62, and the third emission region A72, respectively.

The holograms 522 of the first emission region A52 are configured such that the diffraction efficiency at the red wavelength thereof is the highest, the holograms 532 of the second emission region A62 are configured such that the diffraction efficiency at the green wavelength thereof is the highest, and the holograms 542 of the third emission region A72 are configured such that the diffraction efficiency at the blue wavelength thereof is the highest. With this configuration, the display light having the red wavelength, the display light having the green wavelength, and the display light having the blue wavelength can be efficiently emitted from the first emission region A52, the second emission region A62, and the third emission region A72, respectively.

### Other Modifications

In Embodiment 2 above, the display light generator 21 generates display light in three types of wavelength bands, but may generate display light in two types of wavelength bands. In this case, the hologram light guide plate 22 is provided with only one distribution region having wavelength-dependent holograms such that the display light in the two types of wavelength bands can be distributed to corresponding emission regions.

In Embodiments 1 and 2 and Modifications 1 and 2 above, the information displayed based on the display light emitted from the hologram light guide plate 22 is not limited to the speed per hour, the travelling direction, information indicating that the predetermined condition has been satisfied, and the date and time, and may be changed as appropriate.

In Embodiments 1 and 2 and Modifications 1 and 2 above, the lens effect of the holograms of the emission region for emitting the near-distance display light may be set such that the emission region emits far-distance display light, and the lens effect of the holograms of the emission region for emitting the far-distance display light may be set such that the emission region emits near-distance display light.

In Embodiment 1 and Modifications 1 and 2 above, the half-wave plate 109 is used to generate display light having the first polarization direction and display light having the second polarization direction, but instead of this, a light source and an optical system for generating display light having the first polarization direction and a light source and an optical system for generating display light having the second polarization direction may be separately provided, and these two display lights may be combined by a polarizing beam splitter and incident on the hologram light guide plate 22. Also in Embodiment 2 above, a light source and an optical system for generating display light having the red wavelength, a light source and an optical system for generating display light having the green wavelength, and a light source and an optical system for generating display light having the blue wavelength may be separately provided.

In Embodiment 1 and Modifications 1 and 2 above, another optical element such as a liquid crystal panel may be used instead of the half-wave plate 109 and the actuator 109a in order to set a polarization direction for the display light from the polarizing beam splitter 107.

In Embodiment 1 and Modifications 1 and 2 above, the incident region A11 is provided on the lower surface side of the light guide path 301, and the first emission region A22 and the second emission region A32 are provided on the upper surface side of the light guide path 301, but the incident region A11, the first emission region A22, and the second emission region A32 may be provided on either the upper surface or the lower surface of the light guide path 301. Similarly, in Embodiment 2 as well, the incident region A41, the first emission region A52, the second emission region A62, and the third emission region A72 may be provided on either the upper surface or the lower surface of the light guide path 501.

In Embodiments 1 and 2 and Modifications 1 and 2 above, the spatial light modulator 108 reflects the light emitted from the light source 101, to generate display light corresponding to an image, but may transmit the light emitted from the light source 101, to generate light corresponding to an image.

In Embodiment 1 and Modifications 1 and 2 above, the rotation position of the half-wave plate 109 may be adjusted to change the polarization direction of the display light passing through the half-wave plate 109 and incident on the hologram light guide plate 22 from the first polarization direction or the second polarization direction. In this case, the polarization direction of the display light is shifted from the polarization direction in which the diffraction efficiency in each hologram of the hologram light guide plate 22 is the highest, so that the amount of the display light emitted from the hologram light guide plate 22 can be reduced. Accordingly, the luminance of an image formed in front of the projection region 13 can be changed.

In Embodiments 1 and 2 and Modifications 1 and 2 above, the example in which the present invention is applied to the head-up display mounted on the passenger car 1 has been described, but the present invention can also be applied to other types of image display devices in addition to the vehicle-mounted device.

The configurations of the image display device 20 and the display light generator 21 are not limited to the configurations shown in FIG. 1C and FIG. 2, and can be changed as appropriate.

In addition to the above, various modifications can be made as appropriate to the embodiments of the present invention without departing from the scope of the technical idea defined by the claims.

What is claimed is:

1. An image display device comprising:
a hologram light guide plate; and
a display light generator configured to cause a plurality of types of display light whose states are different from each other in a predetermined optical characteristic to be incident on an incident region of the hologram light guide plate, wherein
the hologram light guide plate includes
a first emission region having a hologram for causing a first type of the display light to form an image,
a second emission region having a hologram for causing a second type of the display light to form an image, and
a distribution region having a hologram dependent on the optical characteristic and configured to guide the first type of the display light and the second type of the display light, out of the plurality of types of display light incident from the incident region, to the first emission region and the second emission region, respectively.

2. The image display device according to claim 1, wherein
the optical characteristic is a polarization direction of the display light,
the first type of the display light has a first polarization direction, and
the second type of the display light has a second polarization direction different from the first polarization direction.

3. The image display device according to claim 2, wherein the display light generator includes an optical element for switching the polarization direction of the display light between the first polarization direction and the second polarization direction.

4. The image display device according to claim 3, wherein the optical element is a half-wave plate, and includes an actuator for rotating the half-wave plate around an optical axis.

5. The image display device according to claim 2, wherein the hologram of the distribution region is configured such that diffraction efficiency in the first polarization direction thereof is the highest and diffraction efficiency in the second polarization direction thereof is the lowest.

6. The image display device according to claim 2, wherein
the hologram of the first emission region is configured such that diffraction efficiency in the first polarization direction thereof is the highest, and
the hologram of the second emission region is configured such that diffraction efficiency in the second polarization direction thereof is the highest.

7. The image display device according to claim 1, wherein
the optical characteristic is a wavelength of the display light,
the first type of the display light has a first wavelength, and
the second type of the display light has a second wavelength different from the first wavelength.

8. The image display device according to claim 7, wherein the hologram of the distribution region is configured such that diffraction efficiency at the first wavelength thereof is the highest and diffraction efficiency at the second wavelength thereof is the lowest.

9. The image display device according to claim 7, wherein
the hologram of the first emission region is configured such that diffraction efficiency at the first wavelength thereof is the highest, and
the hologram of the second emission region is configured such that diffraction efficiency at the second wavelength thereof is the highest.

10. The image display device according to claim 1, wherein the first emission region and the second emission region cause the first type of the display light and the second type of the display light to form images at positions different from each other.
